(19) United States
(12) Patent Application Publication
(10) Pub. No.: US 2017/0080557 A1
(43) Pub. Date: Mar. 23, 2017

(54) Manually Operable Polymeric Well Liner Cutter Guard Device

(71) Applicant: Experience Safety Institute LLC, Bridgewater, NJ (US)

(72) Inventor: Denis Crayon, Hackettstown, NJ (US)

(21) Appl. No.: 14/857,970

(22) Filed: Sep. 18, 2015

(51) Int. Cl. B25H 3/00

(52) U.S. Cl. CPC B25H 3/006

(57) ABSTRACT

The present invention provides a manually operable, polymeric well liner cutter guard device comprising a main body part, two outward sidewall panels containing therebetween a body center having a face, two center sidewalls each having an end surface and each having at least one recess extending inwardly from each end surface, each of the center sidewalls being adjacent to one of the outward sidewall panels.

The present invention relates to a manually operable, polymeric well liner cutter guard device.

Very frequently in many drilling operations, wherein it is either desired or necessary to evaluate the condition of subterranean soils or strata, such is usually undertaken using conventional drilling apparatus and means. Typically during or after a drilling operation a liner, typically a removable polymeric liner, is also introduced into the well bore such that samples of the subterranean soils and or strata can be collected at various depths of the well. Such is useful for example in evaluation of the degree of contamination of subterranean soil caused by a suspected pollutant or suspected polluting source. It is particularly advantageous that such sampling is made possible as the withdrawal of samples at various depths of the well permits for the geological mapping of the originally present soils or subterranean strata, and the relative location of other materials, e.g., pollutants at various subterranean depths. Such can be useful for example where a plurality of such wells are drilled (bored) and evaluated to determine the direction and/or the extent of pollutant concentration relative to the position of the one or more of such wells. Such is advantageous particularly where nearby groundwater sources such as springs, aquifers, are at risk of being contacted by such pollutants as generation of a three-dimensional, subterranean map or model thereof permits for more effective and rapid deployment of equipment useful in minimizing such risk.

In such evaluation of subterranean soils or strata, tubular liners, typically made of a polymeric material such as a polypropylene, polyethylene, or other synthetic polymers are typically used as such can be provided into the well bore quite easily, and can similarly be easily withdrawn when necessary. Such liners are typically cylindrical, more typically of a tubular shape having a diameter which is a very small fraction of the overall length, typically having a diameter to length ratio of not more than about 1:10, usually not more than about 1:25 and most usually is not more than about 1:100 or even smaller such ratios. Conventional liners have a wall thickness of approximately about 0.5-5 mils, more frequently about 0.75-1.5 mils, and lengths numbering several feet, e.g, 2, 3, 4, 5 feet or even longer lengths. Once withdrawn from well bore, advantageously the liner is split along its length so that the content contained within can be withdrawn and/or examined. Typically, this is facilitated by the use of a manually operable, polymeric well liner cutter device which comprises a body and one or more cutter blades contained with in. Such are described in more detail hereinafter, and are known to the relevant art. Such a device typically is non-motorized, and is wholly manually operable and only requires placement, and movement along the length of a liner upon which it is engaged, which can be effectuated by a human operator, without the benefit of any power source, motor, engine, machine, and the like. A drawback of such cutters is that they are prone to be carelessly handled, and the placement of the one or more cutter blades forming part of the device may wholly unintentionally come into contact with a person using the device, or in the near proximity of the device. The exposed cutter blades pose a risk of laceration which is compounded by the fact that when used “in the field”, such cutters may be contaminated with surface rust formed upon cutting points and blade edges, as well as with any materials into which they have come and contact with during prior uses of the cutter. Such may include microorganisms, pollutants, or for that matter any other material which may become entrained upon the said cutter and/or its cutter blades. Such provides an increased risk of immediate injury, and later infection, which the present invention seeks to minimize the risk of.

In one aspect the present invention provides a manually operable, polymeric well liner cutter guard device, which is removably attachable upon a manually operable, polymeric well liner cutter device of the type which are known to the prior art.

In a further aspect the present invention provides a method for extending the useful service life of cutter blades which form a part of a manually operable, polymeric well liner cutter guard device.

In a further aspect the present invention provides a method for reduction accidental injury to workers utilizing a manually operable, polymeric well liner cutter guard device, particularly wherein the said device is used to cut open or slit polymeric well liners.

These and further objects will become more apparent from a reading of the following specification.

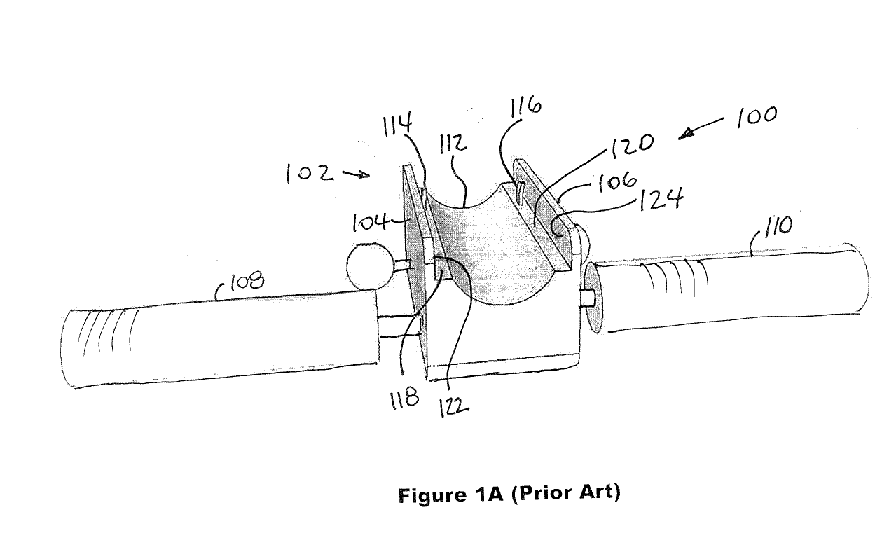

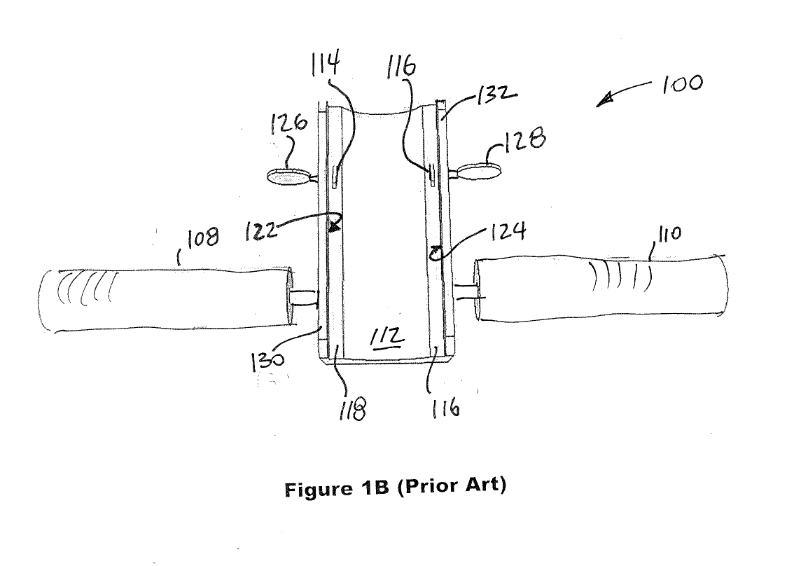

FIGS. 1A and 1B depict various views of a manually operable, polymeric well liner cutter device, which is representative of such a class of prior art device.

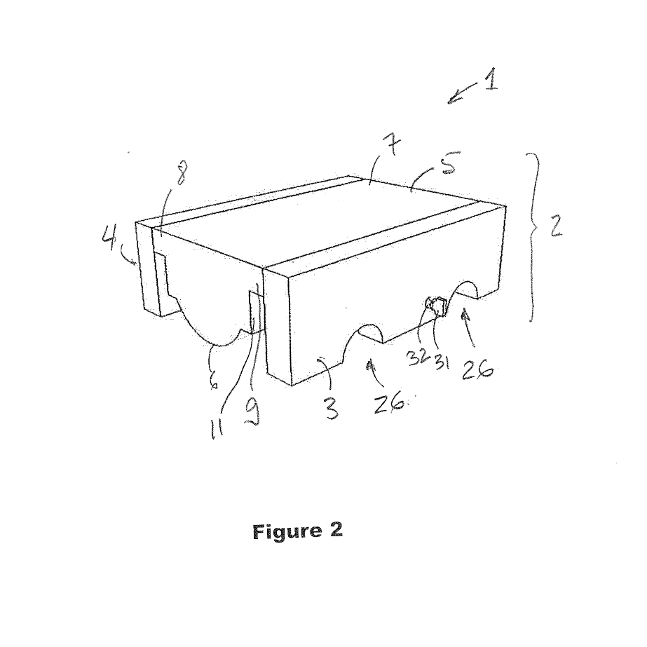

FIG. 2 depicts in a perspective view a preferred embodiment of a manually operable, polymeric well liner cutter guard device according to the present invention.

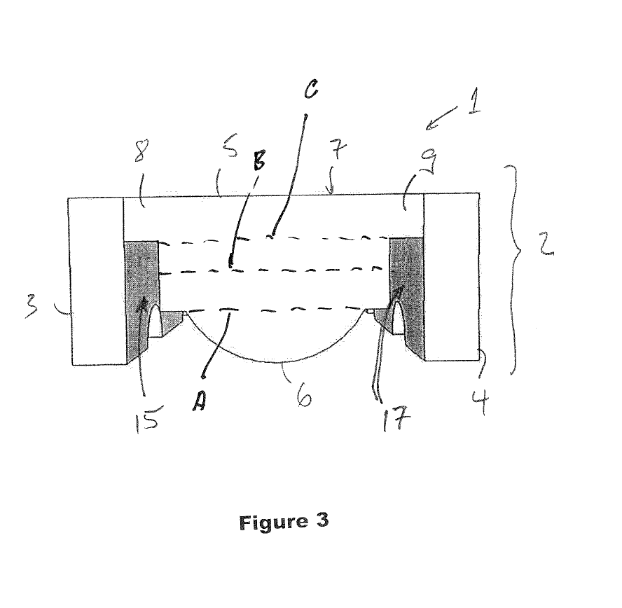

FIG. 3 depicts a plan view of one end of the manually operable, polymeric well liner cutter guard device of the present invention.

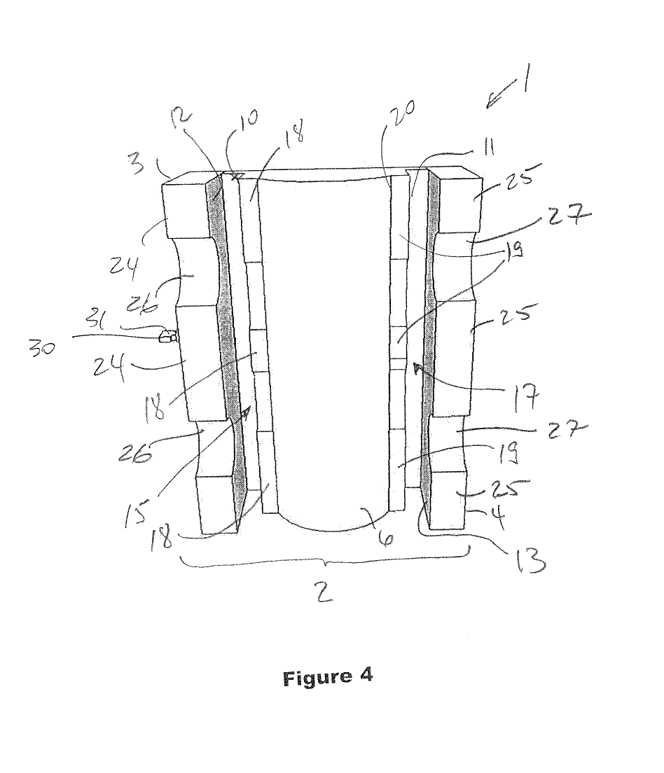

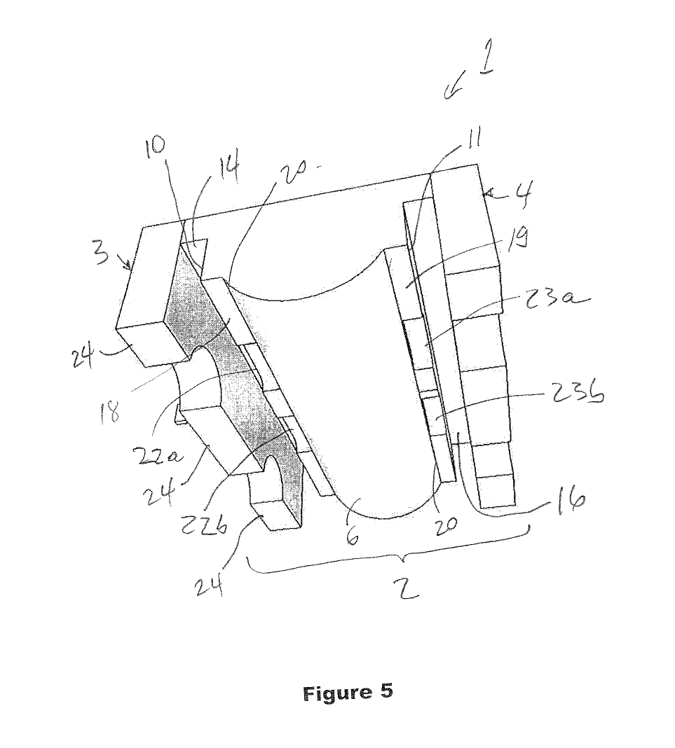

FIGS. 4 and 5 illustrate interior feature of the manually operable, polymeric well liner cutter guard device of FIGS. 2 and 3.

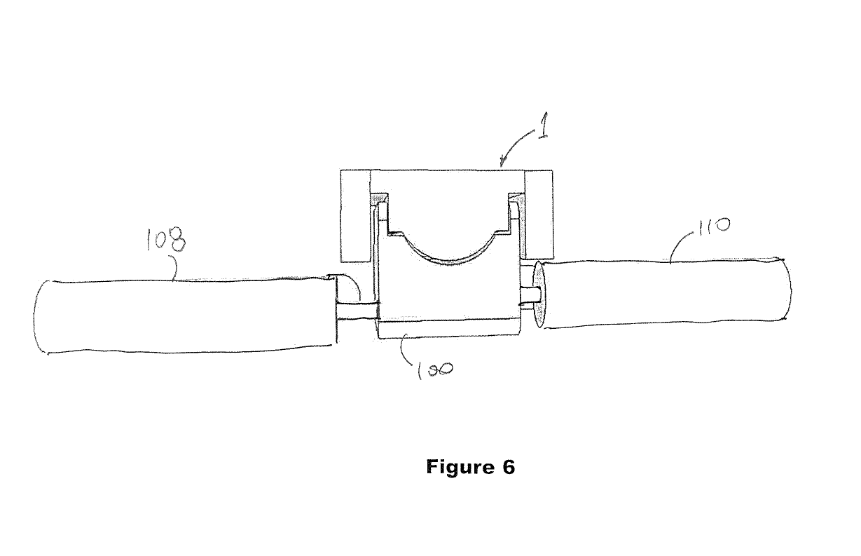

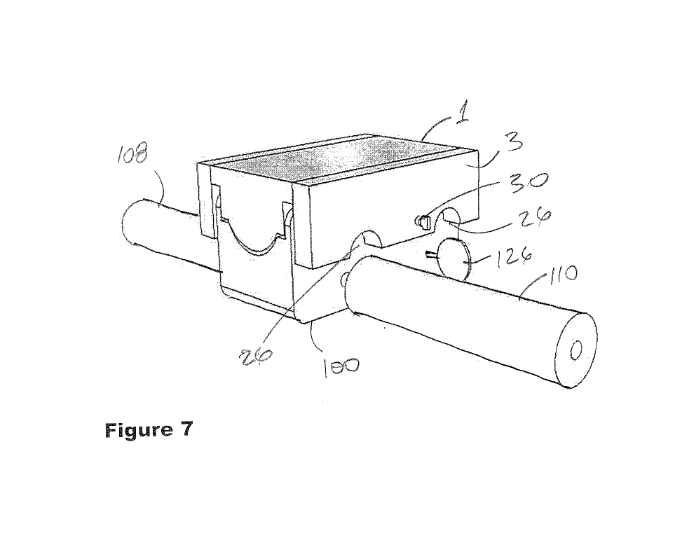

FIGS. 6 and 7 provide two views of the manually operable, polymeric well liner cutter guard device of FIGS. 2-5, removably mounted upon a manually operable, polymeric well liner cutter guard device of FIGS. 1A and 1B.

As noted, the manually operable, polymeric well liner cutter guard device according to the present invention is utilized, or more particularly is removably mountable upon a manually operable, polymeric well liner cutter device. Utilization of a manually operable, polymeric well liner cutter guard device according to the present invention provides a number of benefits. Without limitation, such include:
(a) increased user safety, particularly when a manually operable, polymeric well liner cutter device is used “in the field” to cut or slit open polymeric well liners which may contain a soil or subterranean strata sample which had been withdrawn from a well bore:
(b) extended operating life of cutter blades mounted in or otherwise forming part of a manually operable, polymeric well liner cutter device;
(c) an increase in worker safety, and concomitantly reduced likelihood of unintended injury, such as may be caused by exposed cutter blades of the manually operable polymeric well liner cutter device which may be the cause of immediate injury (laceration, blood loss) and/or subsequent injury (infection) to a worker using the manually operable, polymeric well liner cutter device or even only coming into incidental contact with the said device.

FIGS. 1A and 1B depict various views of a manually operable, polymeric well liner cutter device 100, which is representative of such prior art devices. As can be seen thereon, the device 100 includes a body part 102 having two opposite sidewalls 104, 106 each having extending outwardly therefrom in a generally perpendicular manner a grip handle 108, 110. Within that the said body part 102 is also present in a semicircular concave receiving channel 112 which is arcuate in shape, and is approximately equal in configuration (e.g. or radius) with the exterior or outer wall of a polymeric well liner upon which the device 100 operates. Adjacent to the channel 112 are individual cutter blades 114, 116 which in this embodiment are hook-shaped, but are not necessarily required to have such configuration. Each of the cutter blades 114, 116 extend upwardly from a channel ledge 118, 120 which is positioned inwardly of the adjacent sidewalls 122, 124. According with this present embodiment, wherein at the individual cutter blades 114, 116 are periodically removed and replaced when they become ineffective, the depicted device 100 also includes a pair of locking thumbscrews, here a locking thumbscrew 126, which is used to retain cutter blade 114 in its fixed position, and a similarly corresponding locking thumbscrew 128 which is used to retain cutter blade 116 in its fixed position. As is clearly visible, particularly from the perspective you provided by FIG. 1A, the cutter blades 114, 116 are present between the adjacent sidewalls 122, 124 and extend upwardly from their respective channel ledges 118, 120 extend away therefrom, and do not extend beyond the top edge 130 of sidewall 104, nor beyond the top edge 132 of sidewall 106. Still, as is better understood from FIG. 1B, each of the cutter blades 114, 116 are spaced away from their adjacent sidewalls 122, 124 by sufficient dimensions such that when device 100 is mounted upon, and drawn along the axial or longitudinal direction of the polymeric well liner (not shown) the cutter blades 114, 116 pierce and cut the polymeric well liner in a longitudinal direction. It would thus be easily understood that careless handling of the device 100 still carries an unwanted risk of causing damage to the cutter blades 114, 116 or even worse, unintended laceration or injury to a person.

Reference is now made to the remaining figures which illustrate in various views a preferred embodiment of a manually operable, polymeric well liner cutter guard device 1 according to the present invention. The manually operable, polymeric well liner cutter guard device 1 comprises a main body part 2 which may be formed from a single master block of a material, or can be an assemblage of discrete component parts, as is depicted in the drawing figures. Each configuration has its advantages and disadvantages. The fabrication of a manually operable, polymeric well liner cutter guard device 1, such as may be done according to modern machining techniques from a monolithic block or mass of a material, e.g, a metal such as aluminum, iron, steel, other metal or metal alloy) which substantially reduces any likelihood of loosening of any individual component parts. The fabrication of a manually operable, polymeric well liner cutter guard device 1 from a non-metallic material, such as a synthetic polymeric material of suitable mechanical rigidity and/or stiffness is also foreseen as such may provide a con-commitment reduction in mass a possible reduction in corrosion as well. Such a fabrication may be performed using known techniques, e.g., one or more of: injection molding, casting, machining, 3-D printing, and the like. Similarly the fabrication of the main body part 2 of the manually operable, polymeric well liner cutter guard device 1 from two or more component parts also has advantages in that simplified machining or formation of individual component parts may be made possible, with little or no compromise in the overall utility of the said guard assembly 1. It is of course contemplated that wherein the main body part 2 is formed of two or more individual component parts, that different materials may be used for the component parts, e.g, one or more may be made of a metal or metal alloy, whereas other component parts may be made of synthetic polymeric materials, would, ceramic, or for that matter any material of construction having suitable rigidity and durability to provide a useful service life. Wherein two more component parts are used to form the main body part 2, they can be suitably affixed to one another by any suitable fastener means or assembly, including without limitation mechanical fastening means, including (without limitation) threaded bolts, nuts, threaded bores, threaded recesses, pins, rivets, press-fit parts, nails, staples and the like, and/or chemical means including (without limitation) adhesives, welding, brazing, soldering, and the like, of the component parts. It is also contemplated that one or more surfaces of the main body part 2 may include a flexible or elastomeric material, which may be placed against one or more surfaces of the main body part 2; such flexible or elastomeric material may be slightly compressed and in such a compressed state may provide a friction fit between the main body part 2 and the manually operable, polymeric well liner cutter device which facilitates the removable mounting of the former upon the latter.

The main body part 2 comprises two outward, sidewall panels 3, 4 which are generally parallel to each other and contained there between a body center 5 having a contoured arcuate face 6 opposite from a top surface 7. The body center 5 includes two channel base sections 8, 9 the one either affixed to, or integrally formed as part of the sidewall panel 3, the other also either affixed to, or integrally formed as part of the sidewall panel 4. The body center 5 also includes a pair of parallel, spaced apart center sidewalls 10, 11, which are present at opposite sides of the arcuate face 6 and are respectively parallel to the inner face wall 12 forming part of the sidewall panel 3, and the interface will 13 forming part of the sidewall panel 4. The inner face wall 12 and center sidewall 10 extend outwardly from channel base surface 14 and define a first receiving channel 15, and similarly interface wall 13 and center sidewall 11 extend outwardly from channel base surface 16 and define a second receiving channel 17. The first receiving channel 15 and the second receiving channel 17 are each configured such that a portion of the sidewalls 104, 106 of the manually operable, polymeric well liner cutter device 100 may be received therein. Each of the spaced apart center sidewalls 10, 11 further include an end surface, respectively 18, and 19 parts of which are coincident with the edge 20 of arcuate face 6. Center sidewall 10 also comprises a plurality of recesses 22a, 22b which extend inwardly from the end surface 18 thereof and are configured to accommodate the blade (not shown) of a manually operable, polymeric well liner cutter device 100. Similarly center sidewall 11 also comprises a plurality of similar recesses 23a, 23b which extend inwardly from the end surface 19 thereof, and which are also configured to accommodate the blade (not shown) of a manually operable, polymeric well liner cutter device 100.

Reference is made to FIG. 3, which illustrates certain alternative embodiments in which the profile of the main body part 2 assumes a different configuration. For example in one such alternative embodiment the body center 5 extends from the top surface 7 only to a (preferably generally parallel) planar surface indicated by dotted line “A” which extends through dividing the main body part 2, which is lesser than the prior distance to the contoured arcuate face 6 which is now absent, and the face 6 defined by “A” is not necessarily arcuate, but may be any other configuration, e.g, planar. Similarly, in an alternate embodiment the body In a further embodiment, the 5 extends from the top surface 7 only to a (preferably generally parallel) planar surface indicated by dotted line “B” which extends through dividing the main body part 2, which is lesser than the extent of either “A” or the contoured arcuate face 6, both of which are now absent and the face 6 defined by “B” is not necessarily arcuate, but may be any other configuration, e.g. planar. In a yet further embodiment, the 5 extends from the top surface 7 only to a (preferably generally parallel) planar surface indicated by dotted line “C” which extends through dividing the main body part 2, which is lesser than the extent of either “A”. “B” and of the contoured arcuate face 6, both of which are all now absent, and the face defined by “C” may be any other configuration, e.g. planar. In this manner it is understood that the configuration, dimensions and distance between the top surface 7 and the face 6 of the main body part 5 may vary.

The two outward, sidewall panels 3, 4 desirably also comprise a plurality of recesses therein, which when present may be used to accommodate further parts or elements of manually operable, polymeric well liner cutter device 100. Preferably, such included as is depicted in the enclosed figures although it is to be understood that if desired, and depending upon the exterior configuration of the manually operable, polymeric well liner cutter device 100, such may be positioned in different parts of the outward sidewall panels 3, 4 and/or may be omitted is appropriate or desired. Sidewall panel 3 comprises generally flat end face 24 having a plurality of recesses 26 extending inwardly from the flat end face 24 therefrom. Similarly sidewall panel 4 comprises a generally flat end face 25 also having a plurality of recesses 27 extending inwardly from the flat end face 25 therefrom. In the depicted embodiment, the recesses 26, 27 are generally arcuate configuration however it is to be understood that such is merely a preferred embodiment, but that such is not be considered a limitation therefrom. Other configurations of such recesses, as well as the omission of one or more recesses is also considered to form part of the present invention. When present such recesses within one or both of the outward sidewall panels 3, 4 are advantageously configured to accommodate portions of the manually operable, polymeric well liner cutter device 100, e.g, handles, or locking thumbscrews 126, 128 thereof, if present.

With respect to the recesses 22a, 22b, 23a, 23b, 26 and 27, it is to be understood and appreciated that their number, configuration, and placement (or absence) within the manually operable, polymeric well liner cutter guard device 1 may be varied from that depicted in the accounting drawing figures. Is to be expressly understood that the quantity and the relative positioning of these recesses 22a, 22b, 23a, 23b, 26 and 27 in great part dependent upon the configuration of the parts or elements of manually operable, polymeric well liner cutter device 100 particularly those extending outwardly therefrom. More specifically, the embodiment of the manually operable, polymeric well liner cutter guard device 1 according to the preferred embodiments as described and shown herein has been configured to accommodate the representative manually operable, polymeric well liner cutter device 100 also shown herein. It is nonetheless to be appreciated and understood to be within the scope of the present invention that alternative configurations of manually operable, polymeric well liner cutter guard device 1 are to be foreseen, such modifications may be dictated by a manually operable, polymeric well liner cutter device having a slightly different configuration than depicted in the drawing figures. Is only necessary that the manually operable, polymeric well liner cutter guard device 1, be removably mountable upon a manually operable, polymeric well liner cutter device, and when mounted, obscure the one or more blades present within such a manually operable, polymeric well liner cutter device.

The manually operable, polymeric well liner cutter guard device 1 optionally but desirably also includes at least one locking means, here depicted as a rotatable locking thumbscrew 30 having a flat headed section 31 which may be used to rotate its threaded part 32 into, or out of a sidewall panel, your sidewall panel 3. While not particularly depicted, this be understood that a threaded bore extends through a portion of the sidewall panel 3 and that the threaded part 32 of the rotatable locking thumbscrew 30 is of sufficient length such that when the manually operable, polymeric well liner cutter guard device 1 is mounted upon a manually operable, polymeric well liner cutter device 100, that a part of the rotatable locking thumbscrew 30 can be used to engage a portion of the cutter device 100 and thereby retain the guard assembly 1 mounted thereon, preferably until the rotatable locking thumbscrew 30 is retracted. Such, according to the depicted embodiment is better understood with reference to FIGS. 6 and 7 which illustrates such a configuration. While not specifically shown, it is nonetheless readily understood that the rotatable locking thumbscrew 30 has been sufficiently turned such that a portion of its threaded part contacts a part of sidewall 106 thus temporarily “locking” the mounted manually operable, polymeric well liner cutter guard device 1 in the depicted position. In such a position it is to be understood that the positioning of the recesses 22a, 22b, 23a, 23b relative to the configuration of the manually operable, polymeric well liner cutter device 100 is such that the cutter blades 114, 116 are accommodated within two of these recesses, and the remaining bulk of the manually operable, polymeric well liner cutter guard device 1 shields these cutter blades 114, 116 from unwanted contact. The relative positions of recesses 26 (and, although not shown also of recesses 27) are such that parts of the cutter device 100, namely grip handles 108, 110 and locking thumbscrew 126 (and although not shown, similarly locking thumbscrew 128) are positioned beneath, or may even be partially engaged within one or more of the recesses 26 (and recesses 27).

It is to be understood that the locking means is not necessarily limited to a single locking means, or to a specific locking means depicted in the figures. For example, plurality of rotatable locking thumbscrews may be provided, such that at least one of each is provided in each of sidewall panel 3, as well as sidewall panel 4. Alternative locking means may also be used with or without such locking thumbscrews 30 as depicted. For example is foreseen that any other means, including but not limited to: as a close tolerance or friction fit between a part of a part of the manually operable, polymeric well liner cutter device 100 as well as a part of the manually operable, polymeric well liner cutter guard device 1, the use of different mechanical means or devices such as clips, or internal clamps or an external clamp which engages both a part of the manually operable, polymeric well liner cutter device 100 as well as a part of the manually operable, polymeric well liner cutter guard device 1, as well as providing at least one or more magnets which may be used to removably mount the manually operable, polymeric well liner cutter device 100 to the manually operable, polymeric well liner cutter guard device 1.

It is to be understood that it may be desirable to include a plurality of recesses, particularly the recesses 22a, 22b, 23a, 23b in positions which are essentially symmetrical with respect to the manually operable, polymeric well liner cutter guard device 1 such that even if the manually operable, polymeric well liner cutter guard device 1 is purposely, or inadvertently rotated by 180 degrees of arc, that the cutter blades 114, 116 will still be received within one or more of said recesses and that the manually operable, polymeric well liner cutter guard device 1 may still be removably mounted upon the manually operable, polymeric well liner cutter device 100 notwithstanding such mis-orientation. For example it is wholly foreseen that recesses 22a is extended to merge into recess 22b and thus form one longer or larger recess. And similarly it is wholly foreseen that recess 23a is extended to merge into recess 23b and thus form one longer or larger recess.

It is also to be understood that although it has been shown in the various figures that the body center 5 has a contoured convex arcuate face 6 which approximately corresponds to and complements the curvature of the semicircular concave receiving channel 112 of the manually operable, polymeric well liner cutter device 100, that while such a configuration is preferred in facilitating the proper mounting of the manually operable, polymeric well liner cutter device 100 to the manually operable, polymeric well liner cutter guard device 1, nonetheless such a contoured convex arcuate face 6 is not an essential feature of the present invention.

While the invention is susceptible of various modifications and alternative forms, it is to be understood that specific embodiments thereof have been shown by way of example in the drawings which are not intended to limit the invention to the particular forms disclosed; on the contrary the intention is to cover all modifications, equivalents and alternatives falling within the scope and spirit of the invention as expressed in the appended claims.

1. A manually operable, polymeric well liner cutter guard device which comprises:
a main body part, two outward sidewall panels containing therebetween a body center having a face, two center sidewalls each having an end surface and each having at least one recess extending inwardly from each end surface, each of the center sidewalls being adjacent to one of the outward sidewall panels.

2. A manually operable, polymeric well liner cutter guard device according to claim 1 in which the face of the body center is arcuate.

3. A manually operable, polymeric well liner cutter guard device according to claim 1 in which the face of the body center is generally planar.

4. A manually operable, polymeric well liner cutter guard device according to claim 1 in which each of the two center sidewalls comprises at least two inwardly extending recesses.

5. A manually operable, polymeric well liner cutter guard device according to claim 1, wherein each of the two outward sidewall panels comprise a generally flat end face comprising at least one inwardly extending recess.

6. A manually operable, polymeric well liner cutter guard device according to claim 1 wherein each inwardly extending recess is arcuate.
